(19) United States
(12) Patent Application Publication
(10) Pub. No.: US 2003/0172481 A1
(43) Pub. Date: Sep. 18, 2003

(54) Tube end preparation tool

(76) Inventor: Victor Yehia, West Vancouver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/326,553

(22) Filed: Dec. 23, 2002

Related U.S. Application Data
(63) Continuation-in-part of application No. 10/046,382, filed on Mar. 18, 2002, now Pat. No. 6,578,228.

(51) Int. Cl. B08B 9/023; B08B 9/027

(52) U.S. Cl. 15/104.04; 15/104.095; 15/104.05; 15/104.2; 15/106

(57) ABSTRACT

This invention relates to a novel tool for cleaning the exterior and interior ends of tubes. More particularly, this invention relates to a novel all-purpose tool for cleaning the interior and exterior cut ends of tubes such as copper piping in preparation for subsequent tasks to be performed on the tubes. A tube end preparation tool comprising: (a) a crank; (b) a socket which is associated with the crank and has a tube exterior cleaning member disposed in the interior of the socket; and (c) a brush which is associated with the crank and is suitable for cleaning the interior of a tube.

### REFERENCE TO RELATED APPLICATION

This application is a continuation-in-part of application Ser. No. 10/046,382, filed Jul. 17, 2000.

### TECHNICAL FIELD

This invention relates to a novel tool for cleaning the exterior and interior ends of tubes. More particularly, this invention relates to a novel all-purpose tool for cleaning the interior and exterior cut ends of tubes such as copper piping in preparation for subsequent tasks to be performed on the tubes.

### BACKGROUND OF THE INVENTION

Cleaning the interior and exterior ends of tubes, such as copper piping, is a common problem because the tubes may be dirty or greasy or have foreign residue on the inside and/or outside. The dirt, grease or foreign residue must be removed in preparation for subsequent tasks such as soldering, attaching fittings and the like. Another problem is that when the tubes are cut with cutting tools, the interior ends of the tubes have burrs or rough edges. The problem is prevalent in the plumbing industry where copper tubing is cut by the plumber using a cutting tool and the interior ends of the copper tubing are rough and have burrs which must be removed (which in some cases in mandated by law) before fittings can be applied to the copper tubes and solder applied to connect the fittings with the ends of the copper tubes.

A number of inventions have been developed over the years to deal with these problems. Many are cumbersome or inefficient or cannot be used in confined spaces. To date, there has not been any all-in-one tube end preparation tool that is easy to operate, efficient in cleaning the interior and exterior ends of the copper tubes, and capable of being used in confined areas.

U.S. Pat. No. 2,383,464, Bown, discloses a pipe cleaning tool comprising a pair of offset turn handles 17 and 18, with a male pipe cleaning 11, 15 at one end and a female pipe cleaner 12, 14 at the opposite end. It is stated that the tool is used for cleaning electrical iron cord terminal sockets. The Bown cleaning tool is relatively bulky and suffers from the disadvantage that it cannot be used in confined locations. Furthermore, Bown does not disclose any type of ratchet mechanism for operating the pipe cleaner.

British Patent No. 2,241,450, Grundy, discloses a tool used to chamfer the ends of plastic pipe. The tool comprises a cup shaped housing 10 with a T-shaped spindle 16 and a handle 17. Grundy does not disclose a brush for cleaning the interior of a tube, nor does Grundy disclose any ratchet mechanism which enables the tool to be used in confined places.

U.S. Pat. No. 5,058,327, Buchanan, discloses a T-shaped pipe stripping tool 10. Each of the three legs 14 of the T-shaped section has different size female pipe cleaning brushes 22. The tool is therefore capable of cleaning the exteriors of three different sizes of tubing. A brush 28 is located at the top of the T-shaped section opposite the center leg. The brush can be used as a male member to clean the interior of a tube. Buchanan also discloses a protective sleeve 32 which has an annular flange 34 for removably attaching over the male brush 28. The protective sleeve 32 can be used to guide a tube onto the brush 28. Buchanan does not disclose any ratchet type cranking mechanism which enables the tool to be operated in confined areas.

U.S. Pat. No. 5,263,104, DiBiagio, discloses a T-shaped cleaning device comprising a female pipe cleaning member 20 and an opposite male cleaning brush 22, which can be respectively used for cleaning the exterior and interior of a tube. The female pipe cleaning end 20 and the male pipe cleaning brush 22 can be rotated in either direction by activating a switch 12 which causes the shaft 16 to rotate in the roller bearing journal 18 of head 14. DiBiagio discloses three different sizes of female fittings. However, DiBiagio does not disclose a ratchet cranking feature. Furthermore, DiBiagio does not disclose guides for assisting and fitting the female and male cleaning members under the ends of tubes.

### SUMMARY OF INVENTION

The invention is directed to a tube end preparation tool comprising: (a) a crank; (b) a socket which is associated with the crank and has a tube exterior cleaning member disposed in the interior of the socket; and (c) a brush which is associated with the crank and is suitable for cleaning the interior of a tube. The tool can include a handle associated with the crank.

The tube exterior cleaning member can be a plurality of inwardly protruding wires. The plurality of wires can be mounted on a substrate which fits in the interior of the socket. The substrate can be a flexible woven fabric, plastic or metal.

The brush can comprise bristles mounted on a spine. The socket and the brush can cooperate with at least one ratchet mechanism which can enable the socket and the brush to be moved in one direction only when the crank is moved in a reciprocating manner.

The handle can be a pair of rotational handles, one mounted on each side of the body of the crank, at a location removed from the socket and brush. The socket can contain in the interior thereof a spiral surface (shim) which can hold the protruding wires and substrate of the tube cleaner at an angle to the axis of the socket.

The tool can include a cap with a tube guiding hole therein which can be fitted over the open exterior of the socket. The socket and the brush can be aligned or not aligned with one another on the opposite sides of the body of the crank.

The socket can have in the interior thereof a protruding chamfer surface for centering the tube and cleaning the interior of the end of a tube. As an alternative to the wire cloth, the socket can include in the interior thereof at least one brush which can be rotated by a gear combination which is activated by manipulating the crank handle.

The closed end of the socket can have a ratchet gear thereon, and the ratchet gear can fit within an opening in the crank, which opening can have ratchet teeth which cooperate with the ratchet gear.

The tool can include a brush holder for mounting the brush on the ratchet. The brush holder can have a ratchet gear which fits within an opening on the crank. The handle can be rotationally mounted on a rod which is connected to the crank. The socket and the brush can have a common ratchet gear.

The socket can include in the interior thereof at least one brush without gears and cleaning action on the exterior of a tube end can be obtained by rotating the crank, which rotates the socket.

The surface of the chamfer protrusion can be textured. The tool can include a chamfered protruding surface can be in the central area of a base for the one or more brushes. The spiral shim in the socket can have a stop for holding the protruding wires and substrate (wire cloth) in position. The cap can also have a spiral shim on the interior thereof to correspond with the spiral shim in the socket.

### BRIEF DESCRIPTION OF DRAWINGS

In drawings which illustrate specific embodiments of the invention, but which should not be construed as restricting the spirit or scope of the invention in any way:

FIG. 1 is an isometric view of a first embodiment of the tube end preparation tool, according to the invention.

FIG. 2 is an isometric view of the crank portion of the tube end preparation tool.

FIG. 3 is a plan view of the crank of the tube end preparation tool.

FIG. 4 is an elevation view of the crank of the tube end preparation tool

FIG. 5 is an end view of the crank of the tube end preparation tool.

FIG. 6 is an elevation view of the socket of the tube end preparation tool.

FIG. 7 is a side view of the socket of the tube end preparation tool.

FIG. 8 is a plan view of the socket of the tube end preparation tool.

FIG. 9 is a section view A-A of the socket illustrated in FIG. 8.

FIG. 10 is an elevation view of the brush holder of the tube end preparation tool.

FIG. 11 is a side view of the brush holder of the tube end preparation tool.

FIG. 12 is a plan view of the brush holder of the tube end preparation tool.

FIG. 13 is a section view A-A of the brush holder illustrated in FIG. 12.

FIG. 14 is an elevation view of the tube-guide cap of the tube end preparation tool.

FIG. 15 is a side view of the tube-guide cap of the tube end preparation tool.

FIG. 16 is a plan view of the tube-guide cap of the tube end preparation tool.

FIG. 17 is an isometric view of the tube-guide cap of the preparation tool.

FIG. 18 is a section view of a third embodiment of an aligned socket and brush of the tube end preparation tool.

FIG. 19 is an isometric view of an internal spiral shim of a socket of the tube end preparation tool.

FIG. 20 is an isometric view of the opposite side of the socket of the tube end preparation tool.

FIG. 21 is a section view of the socket of the tube end preparation tool with angled card cloth and spiral shim.

FIG. 22 is an isometric view of a second embodiment of the tube end preparation tool with one handle.

FIG. 23 is an isometric view of a fourth embodiment of the invention comprising a three brush header for insertion in a socket of the tube end preparation tool.

FIG. 24 is an isometric view of a socket into which the three brush header of FIG. 23 fits.

FIG. 25 is an isometric view of an embodiment of three brush header without the gears.

### DETAILED DESCRIPTION OF SPECIFIC EMBODIMENTS OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

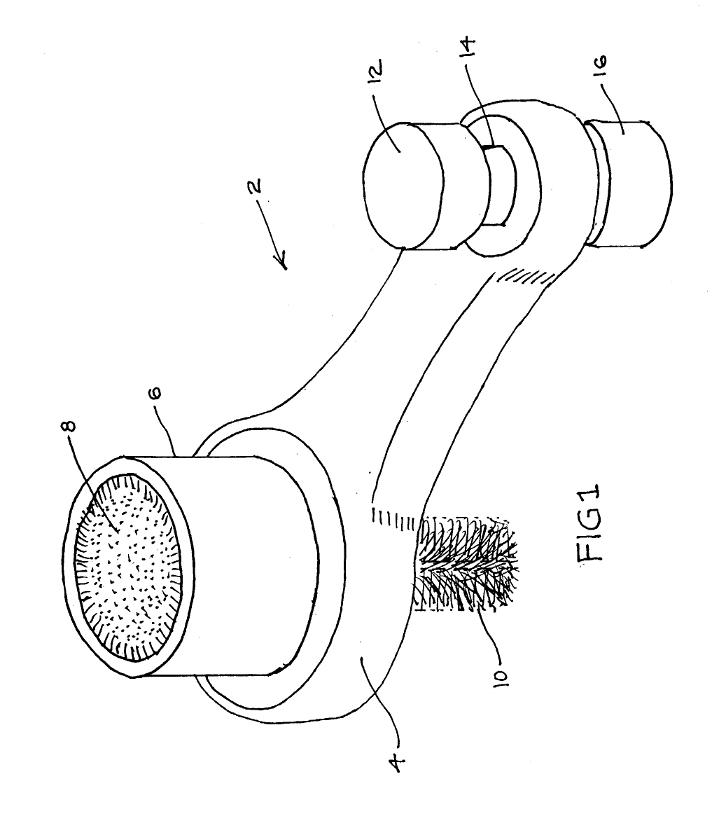

Referring to the drawings, FIG. 1 illustrates an isometric view of a first embodiment of the tube end preparation tool, according to the invention. As seen in FIG. 1, the first embodiment of the tube end preparation tool 2 is constructed of an elongated crank 4 which at the larger end on opposite sides carries a female socket 6, which contains a card cloth 8, and at the opposite side, a male brush 10. The opposite smaller end of the crank 4, on opposite sides, carries a pair of crank handles 12 and 16, which are rotationally mounted on a shaft 14. The card cloth 8 in the interior of female socket 6 comprises a large number of radially inwardly protruding wires arranged in parallel or random rows on a flexible substrate. The substrate can be woven fabric, plastic or metal. The card cloth 8 envelops the interior of the socket 6. While not visible in FIG. 1, the socket 6 and the brush 10, at their respective junctions with the crank 4, are mounted on ratchets which enable the socket 6 and the brush 10 to be rotated in one desired direction only by grasping either of the crank handles 12 and 16, and moving the crank 4 in a reciprocating manner. The pair of handles 12 and 16 permit the user to grip either side of the tool 2.

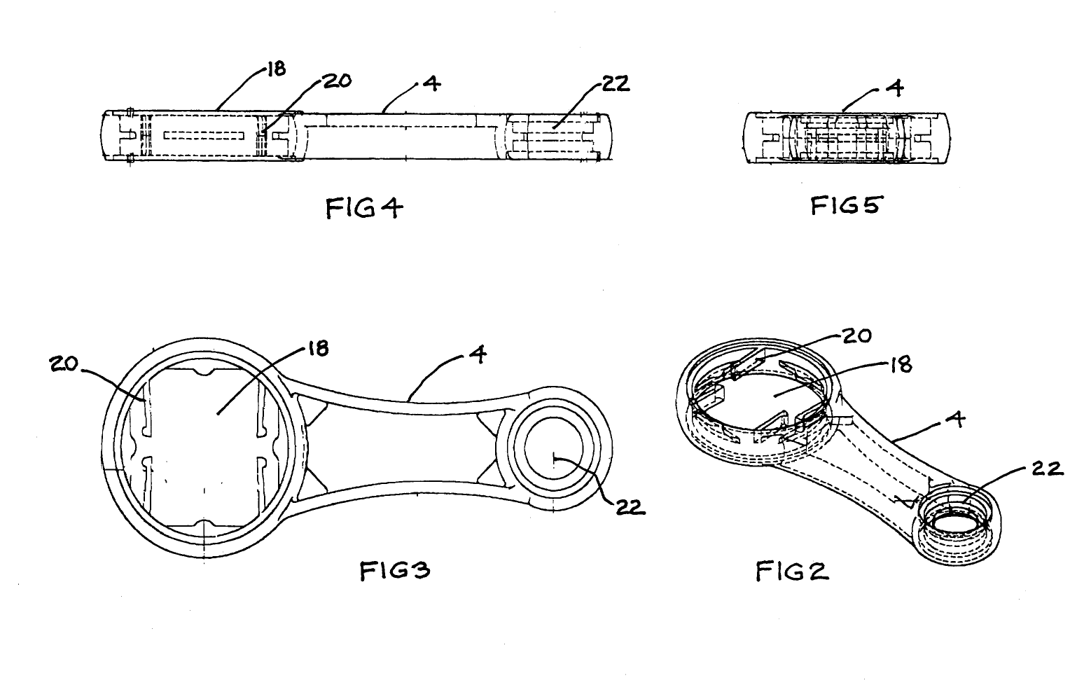

FIG. 2 is an isometric view of the crank portion of the tube end preparation tool. As seen in FIG. 2, the crank 4 has at one larger end a socket opening 18 and at the opposite smaller end a rotation shaft opening 22. Ratchet teeth 20 on the interior of opening 18 impinge on a ratchet gear (not shown, but see FIGS. 6, 7 and 8) and enable the crank 4 to move the socket 6 or brush 10 in one desired direction by moving the crank back and forth.

FIG. 3 is a plan view of the crank of the tube end preparation tool. As seen in FIG. 3, the crank 4 has at one larger end thereof a circular socket and brush receiving opening 18, with inwardly protruding ratchet teeth 20 and at the opposite smaller end a circular opening 22 for accommodating the rotation shaft 14 of the pair of handles 12 and 16.

FIG. 4 is an elevation view of the crank 4 of the tube end preparation tool with socket opening 18, and brush ratchet teeth 20 and shaft opening 22. For completeness, FIG. 5 is an end view of the crank 4 of the tube end preparation tool.

FIG. 6 is an elevation view of the socket of the tube end preparation tool. As seen in FIG. 6, the female socket 6 is constructed so that it has ratchet gears 24 at the base, and in the interior thereof a mounting pin receptacle 28 and a spiral shim 26, which deploys the card cloth 8 (not shown) at an angle. It has been unexpectedly discovered that if the card cloth 8 is deployed at an angle around the interior of the socket 6, better cleaning action on the exterior of the tube to be cleaned is achieved. This is probably due to the fact that by angling the card cloth 8, blanks between the rows of inwardly protruding wires are not aligned around the interior of the socket 6. FIG. 6 also illustrates the upwardly protruding tube chamfer 54 which assists in aligning the end of the tube, but also removing burrs and the like from the end of the tube.

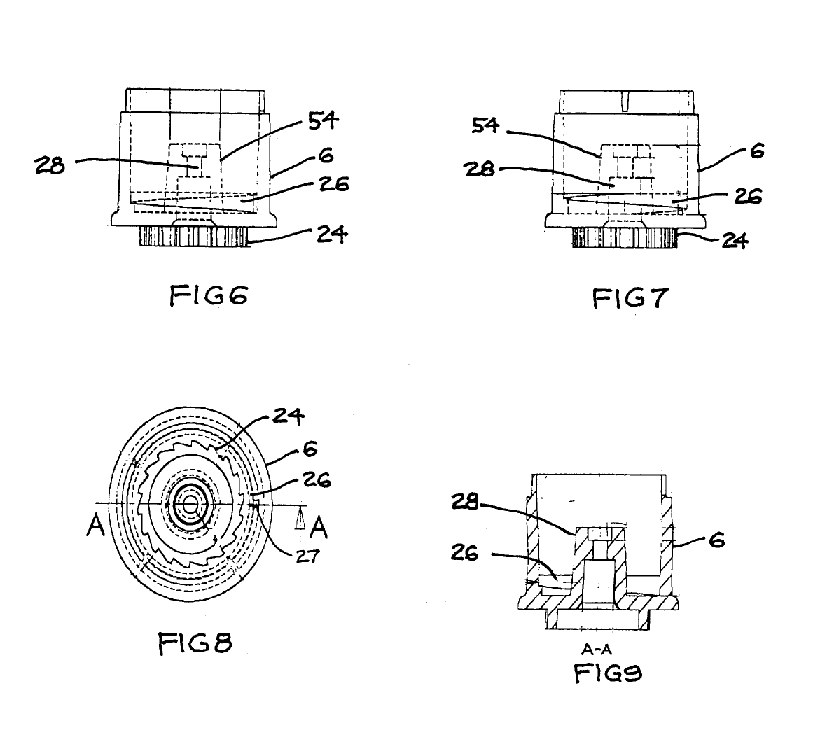

FIG. 7 is a side view of the socket of the tube end preparation tool. FIG. 8 is a plan view of the socket of the tube end preparation tool. FIG. 9 is a section view A-A of the socket of FIG. 8. As seen in FIG. 8 in particular, the female socket 6 is constructed so that it has at its base end a series of ratchet gears 24, which are angled in one direction. When the ratchet gears 24 are set in the interior of the socket opening 18 (see FIGS. 2 and 3), they cooperate with ratchet teeth 20 and provide a unidirectional ratcheting action, when the crank 4 is moved reciprocally by the user. The socket 6 has an internal stop 27 which secures the card cloth and prevents it from moving.

FIG. 10 is an elevation view of the brush holder of the tube end preparation tool. As seen in FIG. 10, the brush holder 30 carries at its top end ratchet gears 32 and mounting pin 34. The brush 10 (see FIG. 1) is not shown in FIG. 10. However, the brush is held in the opening at the bottom of holder 30. The pin 34 fits within receptacle 28 of socket 6 (see FIGS. 6 to 9). The ratchet gear 32, in cooperation with ratchet teeth 20 of crank 4 enables the brush 10 to be rotated in a required direction by manipulating the crank 4 in a reciprocating manner.

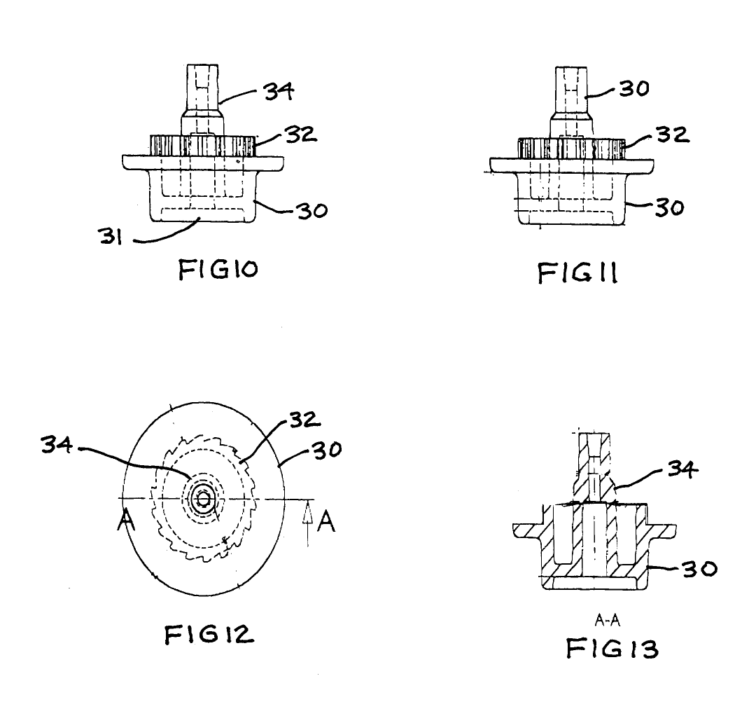

FIG. 11 is a side view of the brush holder of the tube end preparation tool. FIG. 12 is a plan view of the brush holder of the tube end preparation tool. FIG. 13 is a section view A-A of the brush holder of FIG. 12.

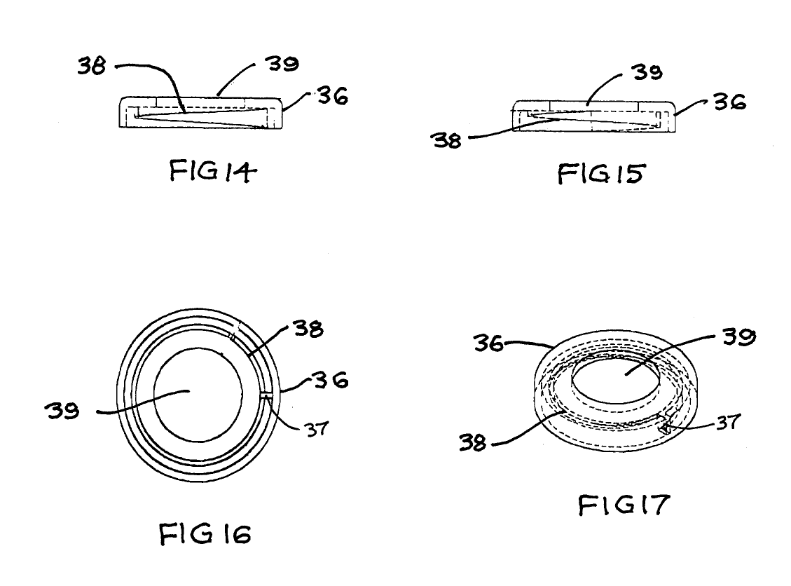

FIG. 14 is an elevation view of the tube-guide cap of the tube end preparation tool. FIG. 15 is a side view of the tube-guide cap of the tube end preparation tool. FIG. 16 is a plan view of the tube-guide cap of the tube end preparation tool. FIG. 17 is an isometric view of the tube-guide cap of the preparation tool. As see in these figures, the tube-guide cap 36 is equipped with an internal spiral shim 38 which enables the cap 36 to hold the card cloth 8 at an angle which cooperates with the spiral shim 26 in the socket 6 (see FIG. 6). The cap 36 also has a stop 37 which secures the card cloth 8 and prevents it from rotating. The tube-guide cap can be screwed over or snapped on the opening of the socket 6 as seen in FIG. 19. The tube-guide cap 36 has an opening 39 in the end (see FIGS. 16 and 17). This opening 39 serves to guide the end of the tube into the interior of the socket 6 and onto the chamfer protrusion 54.

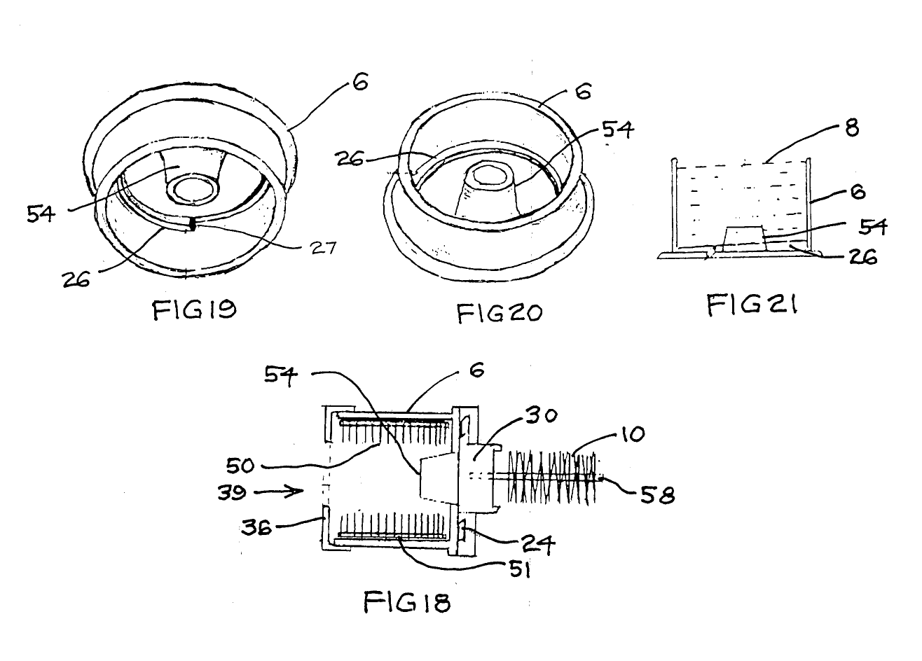

FIG. 18 is a section view of an aligned socket and brush on opposite sides of the tube end preparation tool. As seen in FIG. 18, the female socket 6 carries on the interior circumference thereof a card cloth 50, with substrate 51, which can be formed of a flexible fabric, plastic or metal. The wires of the card cloth 50 protrude radially inwardly and serve the purpose of cleaning the exterior of a tube to be cleaned, when the tube end is inserted into the interior of the socket 48. The interior of the socket 48 also has a tube chamfer 54 to grip the end of the tube and/or clean burrs which may or may not have a textured surface from the interior of the end of the tube. The cap 36 (see FIGS. 14 through 17) is screw- fitted to or is snapped on the free end of the socket 6 and by opening 39 provides a tube guide into the interior of the socket 6. Also to be seen in FIG. 18 is the single set of ratchet gears 24, the brush holder 30 and the brush 10. The brush 10 has a brush spine 58 which carries the bristles.

FIG. 19 is an isometric view of an internal spiral shim of a socket of the tube end preparation tool. FIG. 19 is useful for illustrating the spiral shim 26 on the interior of the socket 6. The spiral shim 26 holds the card cloth (not shown) at an angle which, as explained previously, has unexpectedly been found to provide superior cleaning action to the exterior surface of a tube that is guided into the interior of the socket 6. FIG. 19 also illustrates stop 27 which prevents the card cloth from moving in the socket 6.

FIG. 20 is an isometric view of the opposite side of the socket of the tube end preparation tool. FIG. 21 is a section view of the socket 48 of the tube end preparation tool with angled card cloth 50 and spiral shim 26. As seen in FIG. 21, the card cloth 8 is mounted around the circumference of the interior of the socket 6 at an angle, as dictated by the spiral shim 26. FIG. 20 also illustrates chamfered protrusion 54, which may have either a smooth or rough surface. The latter assists gripping and cleaning action on the table.

FIG. 22 is an isometric view of a second embodiment of the tube end preparation tool with one handle. As seen in FIG. 22, the alternative embodiment of the tube end preparation tool comprises a crank body 42, a female socket 40 for cleaning the exterior end of a tube, and a male brush 44 for cleaning the interior end of a tube. The socket 40 and brush 44 are not in alignment, which may be helpful in certain situations. The tube end preparation tool illustrated in FIG. 22 has only one handle 46, which in certain instances may be desirable. While not visible in FIG. 22, one or both of the socket 40 and the brush 44 are mounted on the same or separate ratchet gear mechanisms, as explained previously, to enable the socket 40 and the brush 44 to be rotated in one direction only, by the user manipulating the crank 42 and handle 46 in a reciprocating manner.

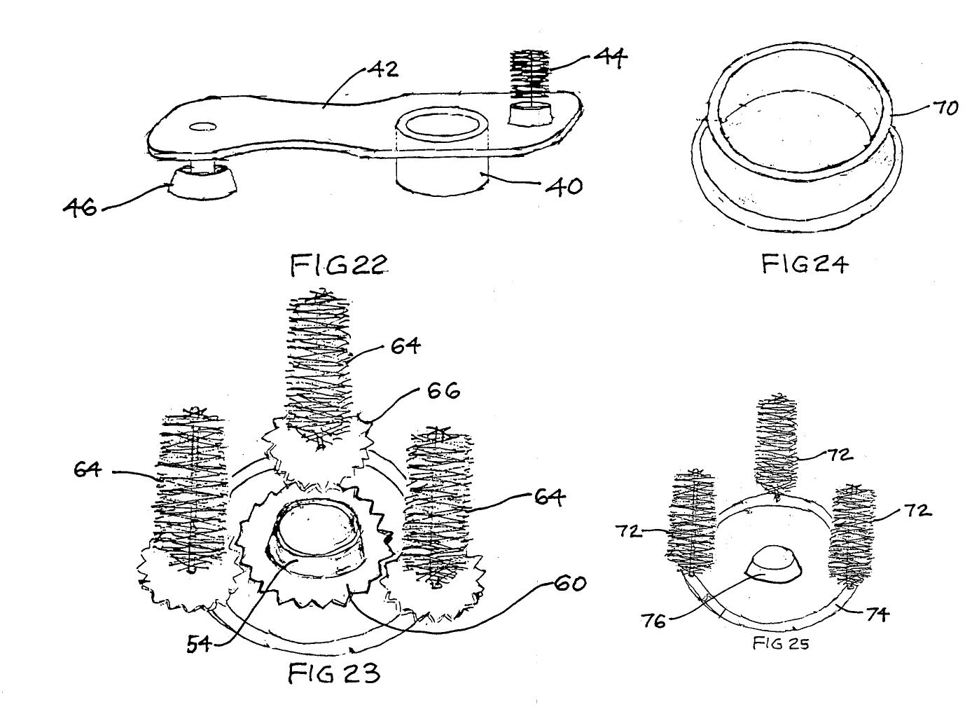

FIG. 23 is an isometric view of a further embodiment of the invention comprising a three brush header for insertion in a female socket of the tube end preparation tool. As seen in FIG. 23, the triple brush combination 64 can be mounted in the interior of a socket to provide a cleaning action upon the exterior surface of a tube that is inserted into the socket. FIG. 23 illustrates a tube chamfer 54 and a master gear 60 which, when rotated by the crank (not shown), meshes with the respective gears 66 at the base of each of the trio of brushes 64 and rotates the brushes accordingly. The trio of brushes 64 may be desirable in some instances for special cleaning, in place of a card cloth. It will be understood that any number of brushes can be used, not necessarily three brushes. It is understood that the cross-section of the socket does not have to be circular. It can be triangular or some other shape that accommodates the brushes.

FIG. 24 is an isometric view of a socket into which the three brush header of FIG. 23 or FIG. 25 fits. As seen in FIG. 24, the socket 70 is similar in construction to the socket 6 of FIG. 19 except there is no internal spiral shim 26 or tube chamfer 54. Thus the three brush combination 64 can fit neatly in the socket 70. Keys or some other securing device can be used to stabilize the brush header combination 64 in the socket 70.

FIG. 25 is an isometric view of an embodiment of three brush header 74 without rotational gears. With this embodiment, the three brushes 72 are stationary within the socket 70 and exterior tube cleaning action is obtained by rotating the socket 70 (see FIG. 24). The rotational gear-free brush header 74 has a central protruding guide 76 which maintains the tube end in the centre of the brush header 74. The guide 76 can have a textured surface which cleans the interior of the end of tube.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A tube end preparation tool comprising:
(a) a crank;
(b) a socket which is associated with the crank and has a tube exterior cleaning member disposed in the interior of the socket; and
(c) a brush which is associated with the crank and is suitable for cleaning the interior of a tube.

2. A tool as claimed in claim 1 including a handle associated with the crank.

3. A tool as claimed in claim 1 wherein the tube exterior cleaning member is a plurality of wires which protrude inwardly in the socket.

4. A tool as claimed in claim 3 wherein the plurality of wires are mounted on a substrate which fits in the interior of the socket.

5. A tool as claimed in claim 4 wherein the substrate is a flexible woven fabric.

6. A tool as claimed in claim 4 wherein the substrate is plastic or metal.

7. A tool as claimed in claim 1 wherein the brush comprises bristles mounted on a spine.

8. A tool as claimed in claim 1 wherein the socket and the brush cooperate with at least one ratchet mechanism which enables the socket and the brush to be moved in one direction only when the crank is moved in a reciprocating manner.

9. A tool as claimed in claim 2 wherein the handle is a pair of rotation handles, one mounted on each side of the body of the crank at a location removed from the socket and brush.

10. A tool as claimed in claim 4 wherein the socket contains in the interior thereof a spiral shim which holds the wires and substrate at an angle to the axis of the socket.

11. A tool as claimed in claim 1 including a cap with a hole therein can be fitted over the exterior of the socket.

12. A tool as claimed in claim 1 wherein the socket and the brush are aligned with one another on the opposite sides of the body of the crank.

13. A tool as claimed in claim 1 wherein the socket and brush are not aligned with one another.

14. A tool as claimed in claim 1 wherein the socket has in the interior thereof a chamfer surface for cleaning the interior of the end of a tube.

15. A tool as claimed in claim 2 wherein the socket includes in the interior thereof at least one brush which is rotated by a gear combination which is activated by manipulating the crank handle.

16. A tool as claimed in claim 8 wherein the closed end of the socket has a ratchet gear thereon, and the ratchet gear fits within an opening in the crank, which opening has ratchet teeth which cooperate with the ratchet gear.

17. A tool as claimed in claim 10 including a brush holder for mounting the brush on the ratchet.

18. A tool as claimed in claim 17 wherein the brush holder has a ratchet gear which fits within an opening on the crank.

19. A tool as claimed in claim 2 wherein the handle is rotationally mounted on a rod which is connected to the crank.

20. A tool as claimed in claim 2 wherein the socket includes in the interior thereof at least one brush and cleaning action on the exterior of a tube end is obtained by rotating the crank, which rotates the socket.

21. A tool as claimed in claim 14 wherein the surface of the chamfer protrusion is textured.

22. A tool as claimed in claim 15 including a chamfered protruding surface in the central area of a base for the at least one brush.

23. A tool as claimed in claim 10 wherein the spiral shim in the socket has a stop for holding the protruding wires and substrate in position.

24. A tool as claimed in claim 11 wherein the cap has a spiral shim on the interior thereof.
